(19) United States
(12) Patent Application Publication
(10) Pub. No.: US 2012/0045001 A1
(43) Pub. Date: Feb. 23, 2012

(54) Method of Generating a Codebook

(76) Inventors: Shaohua Li, Beijing (CN); Wan Lei, Beijing (CN)

(21) Appl. No.: 13/058,610

(22) PCT Filed: Aug. 13, 2008
(86) PCT No.: PCT/EP2008/060647

§ 371 Date: Aug. 3, 2011

(51) Int. Cl. H04L 27/00

(52) U.S. Cl. 375/259

(57) ABSTRACT

A method of generating a mixed codebook including a plurality of codewords for a communication network is provided, wherein the method includes generating a first codeword of a first codeword type according to a first generation scheme, generating a second codeword of a second codeword type according to a second generation scheme which is different to the first generation scheme, and combining the first codeword and the second codeword to a mixed codebook.

### FIELD OF INVENTION

The present invention relates to the field of methods of generating a codebook, in particular to mixed codebooks. Furthermore, the invention relates to a mixed or hybrid codebook, a program element, and a computer-readable medium.

### ART BACKGROUND

In early 2007, the IEEE 802.16 working group has established a new task group, 802.16m, to provide an advanced air interface which amends IEEE 802.16-2004 and 802.16e in order to meet the requirements of next generation mobile networks. One key target of the 802.16m is to improve the throughput of the system. Multiple User Multiple-In-Multiple-Out (MU-MIMO) has been considered as a key technology in IEEE 802.16m. As a matter of fact, MU-MIMO has also been studied widely in 3GPP LTE.

Now, 16m has set a Rapp group to discuss Downlink MIMO (DL MIMO). One open issue is codebook design for close loop (CL) MIMO, which includes CL Single User (SU) MIMO and CL MU MIMO.

Currently, two codebooks are frequently discussed in DL MIMO Rapp. One is 16e codebook, and the other is DFT codebook. However, none of both has an optimal performance in practical systems.

Thus, there may be a need for a method of generating an improved codebook which exhibits improved performance in practical systems.

### SUMMARY OF THE INVENTION

This need may be met by a method of generating a codebook, a codebook, a program element, and a computer-readable medium according to the independent claims. Further embodiments of the present invention are described by the dependent claims.

According to an exemplary aspect of the invention a method of generating a mixed codebook comprising a plurality of codewords for a communication network is provided, wherein the method comprises generating a first codeword of a first codeword type according to a first generation scheme, generating a second codeword of a second codeword type according to a second generation scheme which is different to the first generation scheme, and combining the first codeword and the second codeword to a mixed codebook. In particular, the communication network may be a mobile communication network, e.g. a 3GPP network or an IEEE 802.16m network.

According to an exemplary embodiment a program element is provided, which, when being executed by a processor, is adapted to control or carry out a method of generating a mixed codebook according to an exemplary aspect of the invention.

According to an exemplary embodiment a computer-readable medium, in which a computer program is stored which, when being executed by a processor, is adapted to control or carry out a method of generating a mixed codebook according to an exemplary aspect of the invention.

The terms “codeword” may particularly denote a matrix. A set of matrices forms the codebook, known to both the receiver and the transmitter.

By providing such a mixed codebook it may be possible to provide a codebook for a decoding procedure in a mobile communication which exhibits an improved performance in a practical system. For example, the first scheme may provide codewords specifically adapted for correlated channels while the second scheme may provide codewords specifically adapted for uncorrelated channels or vice versa.

Thus, a gist of an exemplary aspect of the invention may be seen in providing a mixed codebook including different types of codewords wherein one type of codewords is optimized concerning correlated channels while the other type of codewords is optimized concerning uncorrelated channels.

Next, further exemplary embodiments of the method of generating a mixed codebook are described. However, these embodiments also apply to mixed codebook, the program element, and the computer-readable medium.

According to another exemplary embodiment of the method the first generation scheme is a generation scheme adapted to generate codewords for correlated communication channels. In this context the term “adapted” may particularly denote that the respective generated codeword has good performance in the respective communication channel. Thus, it may be said that the respective generated codeword has a performance which is optimized concerning a correlated communication channel. In particular, the first generation scheme may be a generation scheme adapted to generate codewords for a Discrete Fourier Transformation codebook.

According to another exemplary embodiment of the method the second generation scheme is a generation scheme adapted to generate codewords for uncorrelated communication channels. Here as well the term “adapted” may particularly denote that the respective generated codeword has good performance in the respective communication channel. In particular, the second generation scheme may be a generation scheme adapted to generate codewords for a codebook according the IEEE 802.16e standard.

Since a 16e codebook may have better performance for uncorrelated channel and a DFT codebook may have better performance for correlated channel a mixed codebook implementing codewords of both types may exhibit an improved performance in practical systems, due to the fact that in practical systems, the channels of Mobile Stations (MSs) may be a mixture of correlated channels and uncorrelated channels. Specifically, some MSs' channels are correlated, and some MSs' channels are uncorrelated at the same time. Even for the same MS, the correlation of channel may vary. Hence, the mixed codebook may get improved performance both in correlated channel and uncorrelated channel.

According to another exemplary embodiment the method further comprises generating a first plurality of codewords of the first codeword type according to the first generation scheme, and generating a second plurality of codewords of the second codeword type according to the second generation scheme.

That is, each codeword of the first plurality of codewords may be generated according to the first generation scheme but may be different to the other codewords of the first plurality of codewords. Correspondingly the codewords of the second plurality of codewords may be generated according to the second generation scheme but may be different from each other. That is, the term “codeword type” may particularly denote the fact that each codeword denoted as a codeword of this codeword type is generated according to a commonly used generation scheme but may not denote the fact that the corresponding codewords are identical.

According to another exemplary embodiment the method further comprises deciding which one of the plurality of codewords of the first codewords type and/or which one of the plurality of codewords of the second codeword types are implemented into the mixed codebook based on a predetermined criterion. In particular, the first codeword type may be adapted for correlated channels or the first codeword type may be adapted for uncorrelated channels.

According to another exemplary embodiment of the method the criterion is based on a threshold value ρ and the deciding is based on the determination whether one of the plurality of first type codewords lies within a ball of radius ρ around a specific one of the second plurality of second type codewords. That is, it may be possible to determine a distance between each of the plurality of first type codewords and a specific one of the second type codewords and in case one of the first type codewords is located closer than the predetermined radius ρ to the specific second type codeword this first type codeword may be implemented into the mixed codebook. In particular, the respective codeword of the first plurality of codewords may replace the specific one of the second plurality of second type codewords. Alternatively, the respective codeword of the first plurality of codewords may be additionally added to the mixed codebook, i.e. the specific second type codeword may not be removed from the codebook.

According to another exemplary embodiment the method further comprises implementing a specific one of the plurality of first type codewords into the mixed codebook, if it is determined that the specific one of the plurality of first type codewords is in the ball. In particular, it should be noted that in case more than one of the first plurality of first type codewords are in the ball, it may be decided which one of the more than one is implemented into the mixed codebook, e.g. it may be possible to implement all or only the first type codeword which has the lowest distance into the mixed codebook.

Furthermore, it may be possible to implement the specific one of the second plurality of the second type codewords into the mixed codebook in case no first type codeword is in the ball of radius ρ around the specific one of the second plurality of the second type codewords.

According to another exemplary embodiment of the method the first plurality of codewords represents a first L-bits codebook having codewords vₗ and the second plurality of codewords represents a second K-bits codebook having codewords uₖ, wherein l=0, 1, . . . , 2^{L}−1 is valid, and wherein k=0, 1, . . . , 2^{K}−1 is valid.

According to another exemplary embodiment of the method the ball of radius ρ around a specific one of the second plurality of second type codewords is defined as Bᵤ_{ₖ}(ρ)={PᵤεG(N,Q):d(u,uₖ)≦ρ}, wherein d(u,uₖ) is a distance function on the complex grassmann manifold G(N,Q), where N is the number of transmit antenna and Q is the streams number. In particular, the distance may be a chordal distance, a projection two-norm distance or the Fubini-study distance.

According to another exemplary embodiment of the method the mixed codebook may be generated by implementing at least one codeword of the first plurality of codewords into the second codebook.

According to another exemplary embodiment of the method the criterion is based on a threshold value ρ and the deciding is based on the determination whether one of the plurality of second type codewords lies within a ball of radius ρ around a specific one of the second plurality of second type codewords. That is, it may be possible to determine a distance between each of the plurality of first type codewords and a specific one of the second type codewords and in case one of the first type codewords is located closer than the predetermined radius ρ to the specific second type codeword this first type codeword may be implemented into the mixed codebook.

According to another exemplary embodiment of the method the distance dₗ is calculated as dₗ=\sqrt{1−|vₗ^{H}uₖ|²} and the at least one codeword of the first plurality of codewords is implemented into the second codebook in case that dₗ is smaller than a given threshold value ρ for all k.

In other words in order to create new K bits codebook S₀ for both correlated channel and uncorrelated channel, L bits DFT codebook vₗ(l=0, . . . , 2^{L}−1) and K bits 16e codebook uₖ(k=0, . . . , 2^{K}−1) may be created first. It is assumed that L≧K and that N transmit antennas are used in the corresponding communication network used. Furthermore, vₗuₖεC^{N} is valid.

In a first step an initialization may be performed:

M₀={0, . . . , 2^{L}−1}

S₀={φ}(emply set)

k=0

In a second step the distance dₗ between uₖ and vₗ(l=0, . . . , 2^{L}−1) is calculated by

dₗ=\sqrt{1−|vₗ^{H}uₖ|²}.

For the calculation it may be assumed that Γₖ={l|dₗ≦ρ}, and

$${l}_{0} = arg ( {min}_{l ∈ ( {Γ}_{k} ⋂ {M}_{k} )} ( {d}_{l} ) ) ,$$

where ρ is a predefined threshold value. If Γₖ∩Mₖ=φ, uₖ may be set as the kth codeword of the mixed codebook, named gₖ. Otherwise, vₗ_{₀} may be set as the kth codeword of the mixed codebook.

In a third step an updating is performed:

S₀=S₀∪gₖ

Mₖ₊₁=Mₖ\{l₀}

k=k+1

Afterwards the second step is repeated until k=2^{K}−1.

For the second step, it can be seen that if Γₖ is empty, it means that no DFT codewords are allocated in the ball of radius ρ around the line generated by uₖ, which is defined as

Bᵤ_{ₖ}(ρ)={PᵤεG(Mₜ,1): d(u,uₖ)—ρ,∥u∥₂=1}

where d(u,uₖ)=\sqrt{1−|u^{H}uₖ|²}, G(Mₜ,1) denotes grassmann manifold, it is the set of all one-dimension subspaces in C^{N}, Pᵤ denote the line generated by a vector u. If no DFT codewords are in the ball around the line generated by uₖ, the 16e codebook, uₖ, may be selected as the kth codeword of the mixed codebook, which may reduce the quantization error for uncorrelated channel. Otherwise, a suitable DFT codeword in the ball may be selected instead of uₖ as the kth codeword of the mixed codebook. For the sake of clarity it should be noted that d(u,uₖ)=\sqrt{1−|u^{H}uₖ|²} is intended to be only an example of a possible d(u,uₖ) and that other suitable definitions may be used, such as chordal distance, projection two-norm distance or the Fubini-study distance.

Furthermore, it should be noted that, in order to avoid re-selection of the same codewords, the constraint lεΓₖ∩Mₖ may be added. If Γₖ is not empty and l is not founded in Γₖ∩Mₖ, it may mean that no unselected codewords are in the ball around the line generated by uₖ. In this case, 16e codebook may be used in this spatial ball. It shall be noted that with the above procedure, the codebook may be uniqueness.

According to another exemplary embodiment of the method the mixed codebook may be generated by implementing at least one codeword of the second plurality of codewords into the first codebook.

According to another exemplary embodiment of the method the first plurality of codewords represents a first K-bits codebook having codewords vₖ and the second plurality of codewords represents a second P-bits codebook having codewords uₚ, wherein p=0, 1, . . . , 2^{P}−1 is valid, and wherein k=0, 1, . . . , 2^{K}−1 is valid.

According to another exemplary embodiment of the method the ball of radius ρ around a specific one of the second plurality of second type codewords is defined as Bᵤ_{ₚ}(ρ)={PᵤεG(N,Q):d(u,uₚ)≦ρ}, wherein d(u,uₚ) is a distance function on the complex grassmann manifold G(N,Q), where N is the number of transmit antenna and Q is the streams number.

According to another exemplary embodiment of the method the distance dₖ is calculated as dₖ=\sqrt{1−|vₖ^{H}uₚ|²} and the at least one codeword of the second plurality of codewords is implemented into the first codebook in case that dₖ is greater than a given threshold value ρ for all k.

In other words, in order to create new K bits codebook S₀ when the number of codewords in the proposed codebook is larger than that of available 16e codebook (K>P), K bits DFT codebook vₖ(k=0, . . . , 2^{K}−1) and P bits 16e codebook uₚ(p=0, . . . , 2^{P}−1) may be created firstly. Then in a next step an initialization may be performed by:

M₀={0, . . . , 2^{K}−1}

S₀={vₖ(k=0, . . . , 2^{K}−1)}

p=0

In a second step the distance dₖ between vₖ(k=0, . . . , 2^{K}−1) and uₚ is calculated. For the calculation it may be assumed that Γₚ={k|dₖ≦α}, and

$${k}_{0} = arg ( {min}_{k ∈ ( {Γ}_{p} ⋂ {M}_{p} )} ( {d}_{k} ) ) ,$$

where ρ is a predefined threshold. If Γₚ∩Mₚ=φ is valid, the k₀th codeword in S₀ vₖ_{₀} is substituted with uₚ. Otherwise, vₖ_{₀} is kept as the k₀th codeword of S₀.

In a third step an updating is performed by setting:

Mₚ₊₁=Mₚ\{k₀}

p=p+1

Afterwards the second step is repeated until p=2^{P-}1.

The method or procedure according to this exemplary embodiment may be performed when, due to computing complexity, the 16e codebook having a high number of bits may not be able to find. In particular, in case only the 16e codebooks of no more than P bits can be generated following its algorithm. In order to create mixed codebook of K>P bits, the latter described procedure may be used.

Summarizing an exemplary aspect of the invention may be seen in the fact that a mixed codebook based on 16e codebook and DFT codebook is proposed forming a new codebook for closed loop MIMO. As a matter of fact, DFT codebook may be more suitable for correlated channel and 16e codebook may be more suitable for uncorrelated channel. The reason may lay in the fact that DFT codebook comes from strong correlated channel, and 16e codebook may be based on Grassmannian line packing, which is to maximize minimum distance between any pair of codewords. The problem of DFT codebook is that the density of DFT codewords is unevenly in the spatial space. In some spatial space, few DFT codewords are allocated. For correlated channel, this property make DFT codebook more efficient. But for uncorrelated channel, it will degrade the performance, since it may bring about significant quantization error when channel fall into the area which DFT codebook does not cover. Thus, the adding of some 16e codewords in the area where DFT codebook does not cover may increase the performance of the mixed codebook according to an exemplary aspect of the invention compared to common DFT codebooks or 16e codebooks. In particular, the mixed codebook according to an exemplary aspect of the invention may have a good performance in both, i.e. correlated channel and uncorrelated channel. Furthermore, it may save memory space when compared to other IEEE 802.16m candidate codebook. No matter what specific 16m codebook is used the mixed codebook should be used at least partially, since 16m should legacy support 16e which may be a part of the mixed codebook.

For generating the mixed codebook there are several possibilities. For example, a 16e codebook and a DFT codebook may be generated having a given number of codewords. Then it may be determined whether a DFT codeword is located in a ball around a specific 16e codeword. If this is the case this DFT codeword may be implemented into the mixed codebook. In case of several DFT codewords falling into the ball the closest one, i.e. the one having the smallest distance to the specific 16e codeword, may be chosen. The determination may then be performed for each single 16e codeword in order to achieve a codebook having as much codewords as the originally generated 16e codebook. Another possibility may be to start with the DFT codebook and replacing some of the DFT codewords by some of the 16e codebook. The DFT codewords which are replaced may be chosen according to a similar method than that of the already described example, i.e. a ball of a predetermined radius is formed around e.g. the l^{th} 16e codeword, and it is determined whether a DFT codeword is in the ball or not. In case no DFT codeword is in the ball than the l^{th} 16e codeword is used to replace the l^{th} DFT codeword to generate the mixed codebook. Thus, a mixed codebook is generated having as much codewords as the originally generated DFT codebook.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered to be disclosed within this application.

The aspects and exemplary embodiments defined above and further aspects of the invention are apparent from the example of embodiment to be described hereinafter and are explained with reference to these examples of embodiment.

### BRIEF DESCRIPTION OF THE DRAWINGS

FIG. 1 schematically shows simulation results of a sum-rate of 6 bits DFT, 16e and a mixed codebook according to an exemplary embodiment of the invention in uncorrelated Veh A channel.

FIG. 2 schematically shows simulation results of a sum-rate of 6 bits DFT, 16e and a mixed codebook according to an exemplary embodiment of the invention in correlated SCM channel.

FIG. 3 schematically shows simulation results of a sum-rate of 8 bits DFT, a mixed codebook according to an exemplary embodiment of the invention in uncorrelated Veh A channel.

FIG. 4 schematically shows simulation results of a sum-rate of 8 bits DFT, a mixed codebook according to an exemplary embodiment of the invention in correlated SCM channel.

### DETAILED DESCRIPTION

The illustration in the drawings is schematic. It is noted that in different figures, similar or identical elements are provided with the similar or identical reference signs.

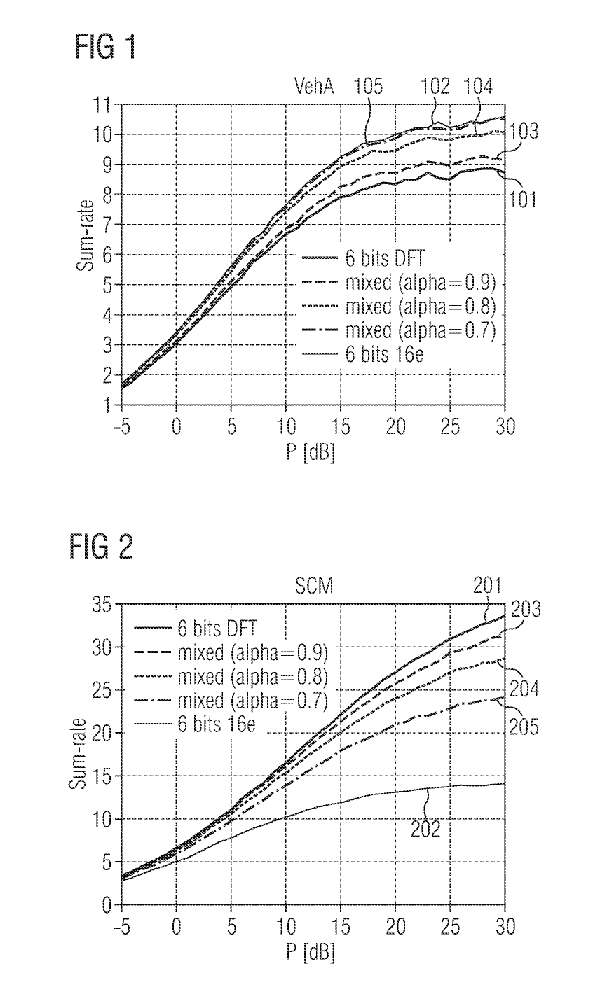

With reference to FIGS. 1 to 4 some simulation results of the performance of a mixed codebook generated according to an exemplary embodiment of the invention are shown. The parameter and their respective values are given in following table.

| | |
|---|---|
| MIMO schemes | Zero-forcing MU MIMO schemes |
| Channel model | Veh A or SCM channel |
| Channel Quality Indicator | so called Philip's channel |
| Feedback | Feedback |
| User selection | so called Greedy user |
| | selection schemes |
| Number of Tx | 4 |
| Number of Rx | 1 per user |
| Number of streams | 1 stream per user |

In detail FIG. 1 schematically shows simulation results of a sum-rate of 6 bits DFT 101, 16e 102 and a mixed codebook 103, 104 and 105 according to an exemplary embodiment of the invention in uncorrelated Veh A channel. In particular, the line 103 indicates the mixed codebook for a threshold value α of 0.7, where α=\sqrt{1−ρ²}. the line 104 indicates the mixed codebook for a threshold value α of 0.8, while the line 105 indicates the mixed codebook for a threshold value α of 0.9.

In detail FIG. 2 schematically shows results of a sum-rate of 6 bits DFT 201, 16e 202 and a mixed codebook 203, 204, and 205 according to an exemplary embodiment of the invention in correlated SCM channel. In particular, the line 203 indicates the mixed codebook for a threshold value α of 0.7, the line 204 indicates the mixed codebook for a threshold value α of 0.8, while the line 205 indicates the mixed codebook for a threshold value α of 0.9.

From FIGS. 1 and 2 it can be seen that the mixed codebook can get better performance than 16e codebook for correlated channel and obtain better performance than DFT codebook for uncorrelated channel. Thus, the mixed codebook may be a good tradeoff of these two kinds of channel.

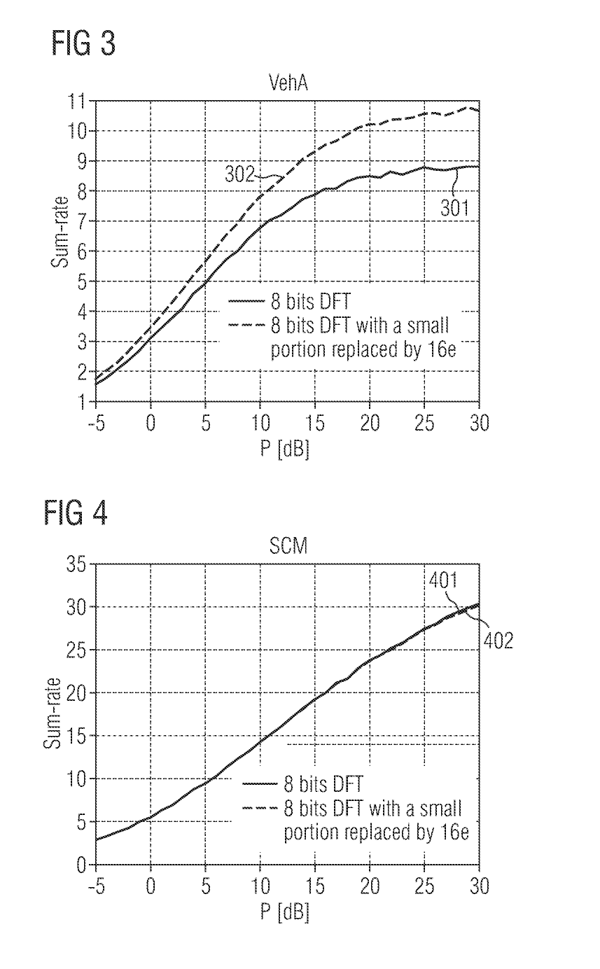

In detail FIG. 3 schematically shows results of a sum-rate of 8 bits DFT 301 and a mixed codebook 302 having a small portion of the DFT codewords replaced by 16e codewords according to an exemplary embodiment of the invention in uncorrelated Veh A channel, while FIG. 4 schematically shows simulation results of a sum-rate of 8 bits DFT 401, and a mixed codebook 402 having a small portion of the DFT codewords replaced by 16e codewords according to an exemplary embodiment of the invention in correlated SCM channel.

Thus, for 8 bits codebook, as shown in FIGS. 3 and 4, it can be seen that no significant performance degradation in correlated channel compared with DFT codebook may arise, while it may still be possible to get gain in uncorrelated channel.

Finally, it should be noted that the above-mentioned embodiments illustrate rather then limit the invention, and that those skilled in the art will be capable of designing many alternative embodiments without departing from the scope of the invention as defined by the appended claims. In the claims, any reference signs shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

### LIST OF REFERENCE SIGNS

101 Sum-rate of 6 bits DFT for VehA channel
102 Sum-rate of 6 bits 16e for VehA channel
103 Sum-rate of 6 bits mixed codebook for VehA channel
104 Sum-rate of 6 bits mixed codebook for VehA channel
105 Sum-rate of 6 bits mixed codebook for VehA channel
201 Sum-rate of 6 bits DFT for SCM channel
202 Sum-rate of 6 bits 16e for SCM channel
203 Sum-rate of 6 bits mixed codebook for SCM channel
204 Sum-rate of 6 bits mixed codebook for SCM channel
205 Sum-rate of 6 bits mixed codebook for SCM channel
301 Sum-rate of 8 bits DFT for VehA
302 Sum-rate of 8 bits mixed codebook for VehA
401 Sum-rate of 8 bits DFT for VehA
402 Sum-rate of 8 bits mixed codebook for VehA

1. A method of generating a mixed codebook comprising a plurality of codewords for a communication network, the method comprising:
generating a first codeword of a first codeword type according to a first generation scheme,
generating a second codeword of a second codeword type according to a second generation scheme which is different to the first generation scheme, and
combining the first codeword and the second codeword to a mixed codebook.

2. The method according to claim 1,
wherein the first generation scheme is a generation scheme adapted to generate codewords for correlated communication channels.

3. The method according to claim 1,
wherein the second generation scheme is a generation scheme adapted to generate codewords for uncorrelated communication channels.

4. The method according to claim 1, further comprising:
generating a first plurality of codewords of the first codeword type according to the first generation scheme, and
generating a second plurality of codewords of the second codeword type according to the second generation scheme.

5. The method according to claim 4, further comprising:
deciding which one of the plurality of codewords of the first codewords type and/or which one of the plurality of codewords of the second codewords type are implemented into the mixed codebook based on a predetermined criterion.

6. The method according claim 5,
wherein the criterion is based on a threshold value ρ and the deciding is based on the determination whether one of the plurality of first type codewords is in the ball of radius ρ around a specific one of the second plurality of second type codewords.

7. The method according claim 6, further comprising:
implementing a specific one of the plurality of first type codewords into the mixed codebook, if it is determined that the specific one of the plurality of first type codewords is in the ball, and/or
implementing the specific one of the second plurality of the second type codewords into the mixed codebook in case no first type codeword is in the ball of radius ρ around the specific one of the second plurality of the second type codewords.

8. The method according to claim 7,
wherein the first plurality of codewords represents a first L-bits codebook having codewords vₗ and the second plurality of codewords represents a second K-bits codebook having codewords uₖ wherein l=0, 1, . . . , 2^{L}−1 is valid, and wherein k=0, 1, . . . , 2^{K}−1 is valid.

9. The method according claim 8,
wherein the ball of radius ρ around a specific one of the second plurality of second type codewords is defined as Bᵤ_{ₖ}(ρ)={PᵤεG(N,Q):d(u,uₖ)≦ρ}, wherein d(u,uₖ) is a distance function on the complex grassmann manifold G(N,Q), where N is the number of transmit antenna and Q is the streams number.

10. The method according claim 9,
wherein an the distance dₗ is calculated as dₗ=\sqrt{1−|vₗ^{H}uₖ|²} and the at least one codeword of the first plurality of codewords is implemented into the mixed codebook in case that dₗ is smaller than a given threshold value ρ for all l.

11. The method according to claim 6,
wherein the first plurality of codewords represents a first K-bits codebook having codewords vₖ and the second plurality of codewords represents a second P-bits codebook having codewords uₚ, wherein p=0, 1, . . . , 2^{P}−1 is valid, and wherein k=0, 1, . . . , 2^{K}−1 is valid.

12. The method according to claim 10,
wherein the mixed codebook may be generated by implementing at least one codeword of the second plurality of codewords into the first codebook.

13. The method according claim 12,
wherein the ball of radius ρ around a specific one of the second plurality of second type codewords is defined as Bᵤ_{ₚ}(ρ)={PᵤεG(N,Q):d(u,uₚ)≦ρ}, wherein d(u,uₚ) is a distance function on the complex grassmann manifold G(N,Q), where N is the number of transmit antenna and Q is the streams number.

14. The method according claim 13,
wherein the distance dₖ is calculated as dₗ=\sqrt{1−|vₖ^{H}uₖ|²} and the at least one codeword of the second plurality of codewords is implemented into the first codebook in case that dₖ is greater than a given threshold value ρ for all k.

15. A computer-readable medium, in which a computer program is stored which, when being executed by a processor, is adapted to control or carry out a method of generating a codebook according claim 1.
